(19) United States
(12) Patent Application Publication
(10) Pub. No.: US 2026/0340809 A1
(43) Pub. Date: Oct. 29, 2026

(54) METHODS FOR COFFEE BEAN DEFECT DETECTION BASED ON SIAMESE NEURAL NETWORKS

(71) Applicant: KUNMING UNIVERSITY, Kunming (CN)

(72) Inventors: Jun HE, Kunming (CN); Xingran HU, Kunming (CN); Sunyan HONG, Kunming (CN); Jing YU, Kunming (CN); Rongan HE, Kunming (CN); Yingpeng MA, Kunming (CN); Tao JIANG, Kunming (CN); Yang SHEN, Kunming (CN); Xinyu GUO, Kunming (CN)

(73) Assignee: KUNMING UNIVERSITY, Kunming (CN)

(21) Appl. No.: 19/555,950

(22) Filed: Mar. 4, 2026

(30) Foreign Application Priority Data
Apr. 23, 2025 (CN) 202510517139.1

(51) Int. Cl. G06T 7/00

(52) U.S. Cl. CPC G06T 7/001; G06T 2207/20081; G06T 2207/20084

(57) ABSTRACT

Disclosed is a method for coffee bean defect detection based on a Siamese neural network. The method includes: obtaining image data of normal coffee beans and four types of defective coffee beans, performing a preprocessing operation on the image data, and dividing the preprocessed image data into a training set, a validation set, and a test set according to a preset ratio; constructing a coffee bean defect detection model based on a dual-branch Siamese neural network, and training the coffee bean defect detection model using the training set to obtain a similarity score; validating and adjusting the trained coffee bean defect detection model using the validation set by employing a mixed-precision training strategy and a dynamic learning rate adjustment technique; and performing defect detection inference on the validated and adjusted coffee bean defect detection model using the test set to complete the coffee bean defect detection.

### CROSS-REFERENCE TO RELATED APPLICATIONS

This application claims priority to Chinese Patent Application No. 202510517139.1, filed on Apr. 23, 2025, the entire contents of which are hereby incorporated by reference.

### TECHNICAL FIELD

The present disclosure relates to a technical field of coffee bean quality inspection, and in particular to a method for coffee bean defect detection based on a Siamese neural network.

### BACKGROUND

In the coffee industry, the quality of coffee beans directly affects the flavor and market value of coffee, and coffee bean defect detection is a critical step for ensuring coffee bean quality. Conventional processes for coffee bean defect detection mainly include manual inspection and rule-based machine vision inspection.

However, manual inspection relies on visual observation and tactile perception to identify defects, which is inefficient and easily affected by subjective factors such as operator fatigue and experience, resulting in unstable detection results and a high likelihood of missed detections or misjudgments. Rule-based machine vision inspection techniques, such as threshold-based segmentation techniques, are highly sensitive to lighting conditions, leading to significant fluctuations in detection accuracy under different lighting environments and making it difficult to adapt to the diversity of coffee bean shapes. With the development of deep learning technologies, some detection methods based on convolutional neural networks have been applied to coffee bean defect detection. Nevertheless, in small-sample learning scenarios, such methods typically require a large amount of data, and when defect samples are scarce, detection accuracy and generalization capability degrade significantly, making it difficult to meet the requirements for efficient and accurate coffee bean inspection in practical production.

Accordingly, there is a need to provide a method for coffee bean defect detection based on a Siamese neural network that can improve detection accuracy and generalization capability in small-sample scenarios, thereby satisfying the practical production requirements for efficient and accurate coffee bean inspection.

### SUMMARY

One or more embodiments of the present disclosure provide a method for coffee bean defect detection based on a Siamese neural network. The method includes: S1: obtaining image data of normal coffee beans and four types of defective coffee beans, performing a preprocessing operation on the image data, and dividing the preprocessed image data into a training set, a validation set, and a test set according to a preset ratio; S2: constructing a coffee bean defect detection model based on a dual-branch Siamese neural network, and training the coffee bean defect detection model using the training set to obtain a similarity score; S3: validating and adjusting the trained coffee bean defect detection model using the validation set by employing a mixed-precision training strategy and a dynamic learning rate adjustment technique; S4: performing defect detection inference on the validated and adjusted coffee bean defect detection model using the test set to complete the coffee bean defect detection. The defect detection inference includes: inputting an image of a coffee bean to be tested and a pre-stored normal coffee bean reference image into the dual-branch Siamese neural network obtained in S3, and calculating a similarity score; in response to the similarity score being lower than a similarity threshold, determining the coffee bean to be tested as a defective coffee bean, and outputting a classification result and a probability value.

The beneficial effects of the present disclosure include, but are not limited to, the following.

In some embodiments of the present disclosure, the coffee bean defect detection model achieves an accuracy and an F1-score of 95.70% and 96.15% respectively on a test set, enabling accurate identification of normal coffee beans and various types of defective coffee beans, such as shriveled beans, shell-attached beans, floating beans, and moldy beans, thereby effectively avoiding missed detections and misdetections and significantly improving the accuracy of coffee bean defect detection.

In some embodiments of the present disclosure, the coffee bean defect detection model is capable of achieving recall of 95.74% on the test set even under small-sample data conditions, effectively addressing the detection challenge caused by the scarcity of defect samples in agricultural scenarios.

In some embodiments of the present disclosure, the average inference time for a single image is only 29.95 milliseconds, which is significantly higher than the efficiency of manual sorting, thereby meeting the requirements for real-time detection in industrial production, effectively reducing quality inspection costs, and improving production efficiency.

In some embodiments of the present disclosure, the method is not only applicable to coffee bean defect detection, but the methodology can also be extended to defect detection of other agricultural products, thereby providing new technical concepts and solutions for automated agricultural inspection.

### BRIEF DESCRIPTION OF THE DRAWINGS

The present disclosure will be further elucidated by way of exemplary embodiments, which are described in detail with reference to the accompanying drawings. These embodiments are not limiting. In these embodiments, the same reference numerals denote the same structures, wherein:

FIG. 1 is a flowchart illustrating an exemplary process of a method for coffee bean defect detection based on a Siamese neural network according to some embodiments of the present disclosure.

FIG. 2 is a diagram illustrating images and descriptions of different types of coffee beans according to some embodiments of the present disclosure.

FIG. 3 is an exemplary flowchart illustrating an image preprocessing process according to some embodiments of the present disclosure.

FIG. 4 is a diagram illustrating an exemplary structure of an improved ResNet18 network according to some embodiments of the present disclosure.

FIG. 5 is a diagram illustrating evaluation results of test classification performance according to some embodiments of the present disclosure.

### DETAILED DESCRIPTION

To more clearly illustrate the technical solutions in the embodiments of the present disclosure, the drawings used in the description of the embodiments will be briefly introduced below. Obviously, the drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

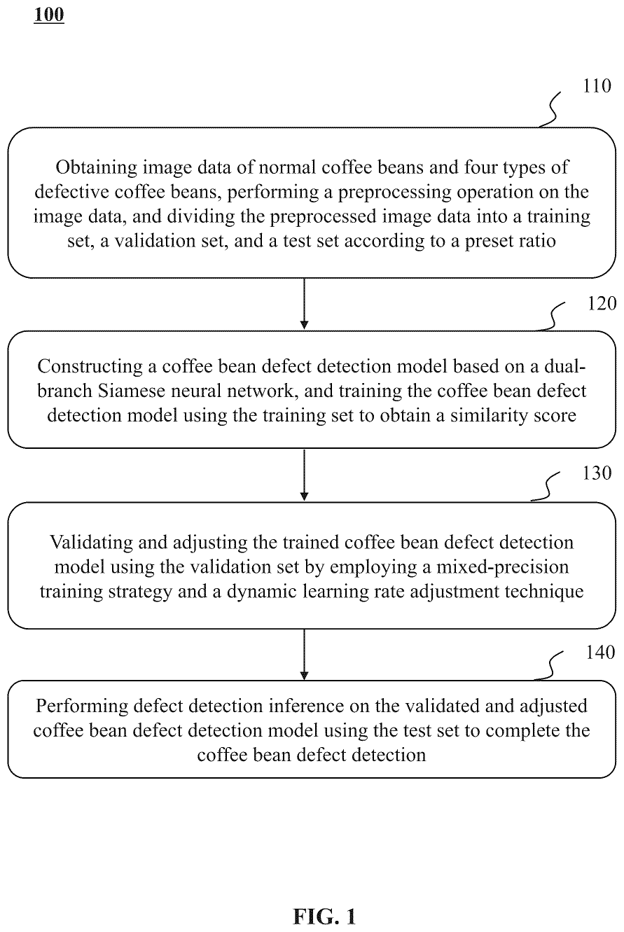

FIG. 1 is a flowchart illustrating an exemplary process of a method for coffee bean defect detection based on a Siamese neural network according to some embodiments of the present disclosure.

In some embodiments, as shown in FIG. 1, a process 100 may be executed by a processor, and the process 100 may include steps 110-140.

In some embodiments, the processor may include a central processing unit (CPU), an application-specific integrated circuit (ASIC), an application-specific instruction-set processor (ASIP), a physics processing unit (PPU), a digital signal processor (DSP), a processor, a microprocessor unit, a reduced instruction set computer (RISC), a microprocessor, or any combination thereof. In some embodiments, the processor may be local or remote. In some embodiments, the processor may be implemented on a cloud platform. Merely by way of example, the cloud platform may include a private cloud, a public cloud, a hybrid cloud, a community cloud, a distributed cloud, an internal cloud, a multi-layer cloud, or any combination thereof.

In 110, obtaining image data of normal coffee beans and four types of defective coffee beans, performing a preprocessing operation on the image data, and dividing the preprocessed image data into a training set, a validation set, and a test set according to a preset ratio.

The normal coffee beans refer to coffee beans having no obvious appearance defects.

The four types of defective coffee beans refer to four types of coffee beans having different defects. For example, the four types of defective coffee beans may include floating beans, moldy beans, shell-attached beans, and shriveled beans.

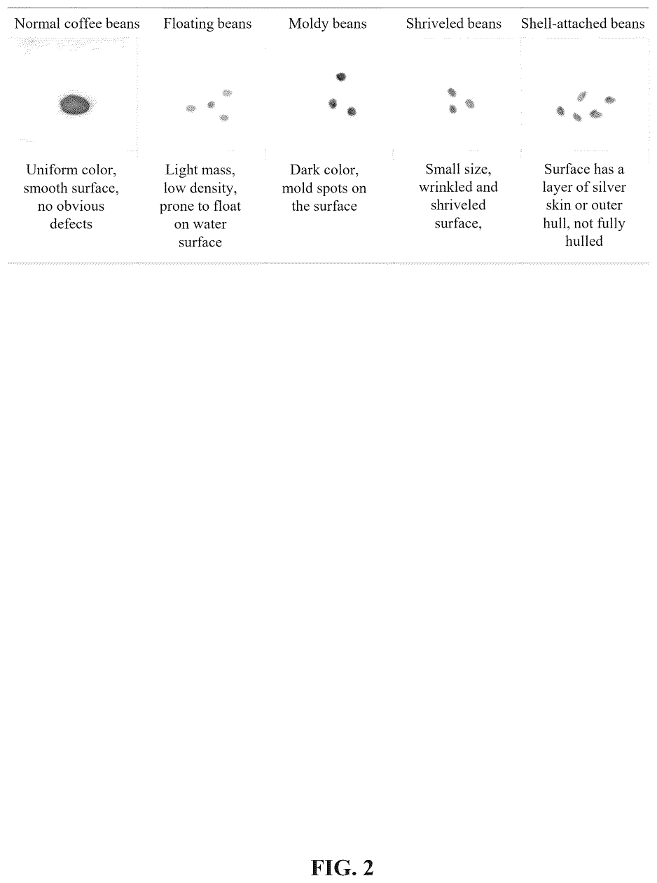

FIG. 2 is a diagram illustrating images and descriptions of different types of coffee beans according to some embodiments of the present disclosure.

In some embodiments, as shown in FIG. 2, the normal coffee beans have a uniform color and a smooth surface without obvious defects; the floating beans have a relatively light mass and low density and are prone to floating on a water surface; the moldy beans have a darker color and mold spots on the surface; the shriveled beans have a smaller size with wrinkled and shriveled surfaces; and the shell-attached beans have a layer of silver skin or outer shell on the surface and are not completely hulled.

The image data refers to image data capable of reflecting surface conditions of the coffee beans.

For more details regarding how the image data is acquired, reference may be made to the related descriptions below.

The preprocessing operation refers to standardized processing performed on the image data.

In some embodiments, the preprocessing operation may include grayscale conversion, normalization, or the like.

For more details regarding the grayscale conversion and the normalization, reference may be made to the related descriptions below.

The preset ratio refers to a ratio used to divide the training set, the validation set, and the test set. For example, when the preset ratio is 7:1:1, the training set, the validation set, and the test set may be divided according to a ratio of 7:1:1.

In some embodiments, the preset ratio may be preset by a technician based on experience.

The training set refers to a dataset used to train a coffee bean defect detection model. The training set is used to adjust learning parameters of the coffee bean defect detection model during a model training process. The learning parameters include parameters such as weights and biases.

The validation set refers to a dataset used to validate and adjust the trained coffee bean defect detection model. The validation set is used to adjust hyperparameters of the model during the model training process. The hyperparameters include a count of network layers, a count of network nodes, a count of iterations, a learning rate, or the like.

The test set refers to a dataset used to test the coffee bean defect detection model after validation and adjustment.

In some embodiments, the training set, the validation set, and the test set are composed of image data, and the image data includes the image data of normal coffee beans and the image data of four types of defective coffee beans.

In some embodiments, the processor may divide the image data according to the preset ratio to form the training set, the validation set, and the test set. The preset ratio may be set in advance, for example, 8:1:1. In some embodiments, there is no data overlap among multiple training samples in the training set, the validation set, and the test set. The absence of data overlap means that a same data entry (i.e., one training sample) exists only in one of the training set, the validation set, and the test set.

In some embodiments, the processor may obtain the image data of normal coffee beans and four types of defective coffee beans; construct an image pair dataset using a balanced sampling strategy to the image data, and divide the image pair dataset according to the preset ratio; convert Red, Green, Blue (RGB) images in the image pair dataset into single-channel grayscale images, set the converted single-channel grayscale images to have two different pixel configurations respectively for model training and defect detection inference, and perform pixel-value normalization.

In some embodiments, a manner for obtaining the image data includes: using a high-resolution industrial camera to obtain the image data of the normal coffee beans and the four types of defective coffee beans under a fixed lighting condition and in an environment with a consistent image background.

For example, the fixed lighting condition may be set as: an LED light source with a color temperature of 5500 K and an illuminance of 1200 lux; the high-resolution industrial camera may have a model number of KS2A543-3.0; the environment with a consistent image background may be set on a sorting machine conveyor belt to avoid environmental interference; and 170 RGB-format images (with a resolution of 2560×1920) may be collected for each type of coffee beans (including the normal coffee beans and the four types of defective coffee beans).

The balanced sampling strategy refers to a sampling strategy in which image pairs cover all coffee bean types and the image pairs are reasonably distributed among the coffee bean types.

The image pair dataset refers to a dataset including a plurality of image pairs. Each image pair includes two images and is annotated with a binary classification label. The binary classification label refers to a binary marker used to indicate a relationship between the two images in the image pair. For example, in the binary classification label, a label “1” indicates that the two images belong to a same type of coffee bean (for example, both being images of normal coffee beans or both being images of a same type of defective coffee beans), and a label “0” indicates that the two images belong to different types of coffee beans (for example, an image of a normal coffee bean and an image of one of the four types of defective coffee beans).

In some embodiments, the image pair dataset is constructed in the following manner: each image pair includes two images and is annotated with a binary classification label. For same-type coffee bean pairs, the processor may randomly select, with replacement, two images from images of coffee beans belonging to a same category (for example, normal coffee beans or a certain type of defective coffee beans) to construct a same-type coffee bean pair, and annotate the same-type coffee bean pair with a label “1”. For different-type coffee bean pairs, the processor may randomly select, with replacement, two images from images of coffee beans belonging to different categories (for example, normal coffee beans and a certain type of defective coffee beans) to construct a different-type coffee bean pair, and annotate the different-type coffee bean pair with a label “0”.

For example, when the balanced sampling strategy is applied to image data of each type of coffee beans (including the normal coffee beans and the four types of defective coffee beans): two images are randomly selected from image data of the normal coffee beans and paired to generate same-type coffee bean pairs of normal coffee beans, and the same-type coffee bean pairs are annotated with a label “1”; two images are randomly selected from image data of each of the four types of defective coffee beans and paired to generate same-type coffee bean pairs of defective coffee beans, and the same-type coffee bean pairs are annotated with a label “1”; two images are randomly selected from image data of all coffee beans and paired to generate different-type coffee bean pairs, and the different-type coffee bean pairs are annotated with a label “0”; and all the same-type coffee bean pairs, the different-type coffee bean pairs, and corresponding labels are combined to construct the image pair dataset.

In some embodiments, the processor divides the image pair dataset according to a preset ratio.

For more details regarding the preset ratio, reference may be made to the detailed description of step 110 in FIG. 1.

For example, when the image pair dataset includes 88,005 image pairs, the processor may divide the image pair dataset according to the preset ratio (for example, 7:1:1) such that: the training set accounts for 77.66% and includes 68,265 image pairs; the validation set accounts for 11.23% and includes 9,870 image pairs; and the test set accounts for 11.23% and includes 9,870 image pairs.

In some embodiments, a ratio between same-type coffee bean image pairs and different-type coffee bean image pairs in the image pair dataset is approximately 1:1, and a ratio between different-type coffee bean image pairs and normal coffee bean image pairs is approximately 1.7:1. In some embodiments, the ratio between the same-type coffee bean image pairs and the different-type coffee bean image pairs, and the ratio between the different-type coffee bean image pairs and the normal coffee bean image pairs, may be preset by a technician based on requirements and experience.

For example, the training set includes 68,265 image pairs (including 19,900 normal pairs, 14,365 defective pairs, and 34,000 mixed pairs), the validation set includes 9,870 image pairs (including 4,950 normal pairs, 820 defective pairs, and 4,100 mixed pairs), and the test set includes 9,870 image pairs (including 4,950 normal pairs, 820 defective pairs, and 4,100 mixed pairs). The normal pairs refer to image pairs of normal coffee beans. The defective pairs refer to image pairs of same-type defective coffee beans. The mixed pairs refer to image pairs of different types of coffee beans (for example, a normal coffee bean and a certain type of defective coffee bean, or different types of defective coffee beans).

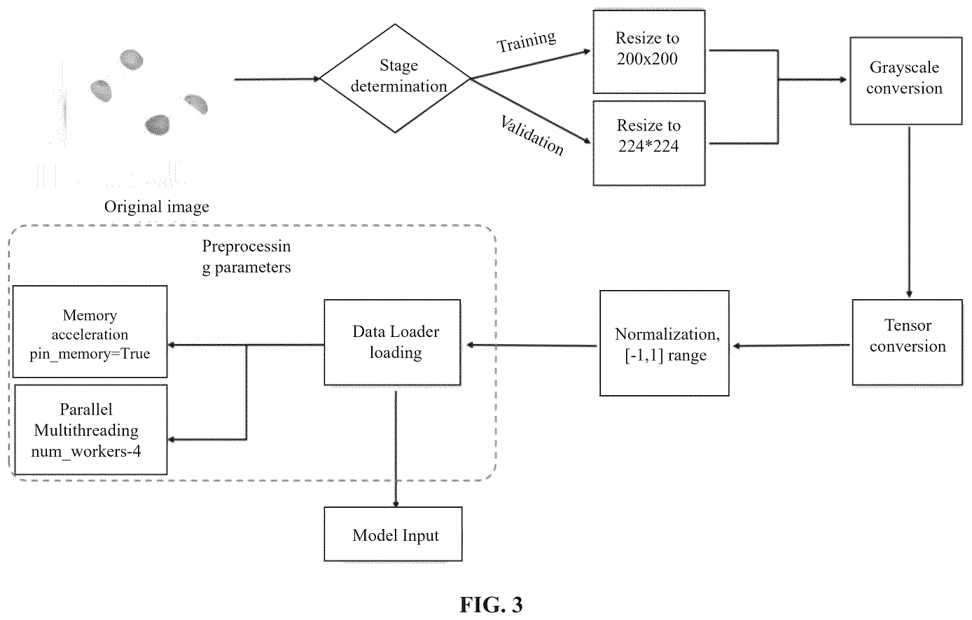

FIG. 3 is an exemplary flowchart illustrating an image preprocessing process according to some embodiments of the present disclosure.

In some embodiments, as shown in FIG. 3, before dividing the training set, the validation set, and the test set according to the preset ratio, the processor may convert RGB images in the image pair dataset into single-channel grayscale images, set the converted single-channel grayscale images to two different pixel configurations respectively for model training and defect detection inference, and perform pixel-value normalization.

In some embodiments, the processor may convert the RGB images into the single-channel grayscale images by weighted grayscale conversion. For example, an expression for converting an RGB image into a single-channel grayscale image is as follows:

I_{gary}=@₁R+@₂G+@₃B

wherein I_{gary} represents a pixel value of the single-channel grayscale image; R, G, and B respectively represent pixel values of red, green, and blue channels; and @₁, @₂, and @₃ respectively represent weights of the red, green, and blue channels. For example, @₁, @₂, and @₃ may be set to 0.299, 0.587, and 0.114, respectively.

In some embodiments, the two different pixel configurations include a pixel configuration for the model training and a pixel configuration for the defect detection inference, and the pixel configuration for the defect detection inference and the pixel configuration for the model training are set to different values.

The pixel configuration for the model training specifies pixel values of single-channel grayscale images used during the model training.

The pixel configuration for the defect detection inference specifies pixel values of single-channel grayscale images used during the defect detection inference.

The pixel configuration for the model training may be set as follows: during the model training, a size of the single-channel grayscale images is uniformly set to 200×200 pixels, for the purpose of maintaining consistency of the training data while reducing computational load.

The pixel configuration for the defect detection inference may be set as follows: during the defect detection inference, a size of the single-channel grayscale images is uniformly set to 224×224 pixels, in order to adapt to an actual industrial camera resolution or to optimize feature extraction.

The pixel-value normalization refers to an operation normalizing pixel values of the single-channel grayscale image to a range of [−1, 1]. For example, the pixel-value normalization may be expressed as follows:

$${I}_{norm} = \frac{{I}_{gray} - 127.5}{127.5}$$

wherein Iₙₒᵣₘ represents a normalized pixel value of the single-channel grayscale image. When the pixel values of the single-channel grayscale image are represented in 8-bit binary form, the pixel value range is 0-255, and a midpoint value is 127.5.

In some embodiments of the present disclosure, image pairs are constructed by adopting fixed acquisition specifications with consistent lighting condition and background, together with the balanced sampling strategy, thereby improving accuracy and recall of the test set under each small-sample condition and effectively addressing the problem of scarce defect samples in agricultural scenarios. Grayscale image conversion and mixed-precision training reduce inference time per image, satisfying real-time detection requirements in industrial production and significantly lowering quality inspection costs. Meanwhile, the framework achieves high recognition accuracy for subtle defects such as shrinkage, mildew, and shell-attached conditions, and can be extended to detection of other agricultural products, thereby providing a general technical solution for agricultural automation.

In 120, constructing a coffee bean defect detection model based on a dual-branch Siamese neural network, and training the coffee bean defect detection model using the training set to obtain a similarity score.

The dual-branch Siamese neural network refers to a neural network configured to construct the coffee bean defect detection model. For example, the dual-branch Siamese neural network may be a Siamese network architecture composed of two branches having identical structures and shared weights.

The coffee bean defect detection model refers to a model configured to determine the similarity score between an image of a coffee bean to be tested and a normal coffee bean reference image. In some embodiments, the coffee bean defect detection model may be a machine learning model, such as a convolutional neural network (Convolutional Neural Network, CNN).

In some embodiments, the processor may perform at least one iteration on an initial coffee bean defect detection model based on the training set, including: inputting the training set into the initial coffee bean defect detection model constructed using the dual-branch Siamese neural network; constructing a loss function based on similarity scores output by the initial coffee bean defect detection model; and iteratively updating parameters of the initial coffee bean defect detection model based on the loss function using various techniques. Further details regarding iterative updating of parameters of the initial coffee bean defect detection model may be found in the related description of step 130 in FIG. 1.

The similarity score refers to a similarity value between two coffee bean images. In some embodiments, the higher the similarity value is, the higher the similarity score, indicating that the two coffee bean images are more similar.

In some embodiments, the coffee bean defect detection model may be obtained through training.

In some embodiments, training the initial coffee bean defect detection model based on the training set may include a plurality of single forward computations. A single forward computation refers to a process in which an image pair is input into the coffee bean defect detection model and a similarity score is output.

In some embodiments, for a single forward computation, the processor may construct an improved feature extractor of the dual-branch Siamese neural network, and input the training set into the improved feature extractor to obtain feature extraction results. The improved feature extractor outputs feature vectors, wherein the pixel configuration for the defect detection inference and the pixel configuration for the model training are set to different values. Corresponding elements of two different feature vectors in the feature extraction results are subtracted to calculate an L2 norm difference, thereby generating a difference vector D. A three-layer classifier is constructed, and the difference vector D sequentially passes through a first fully connected layer, a second fully connected layer, and an output layer, so as to output the similarity score.

The improved feature extractor refers to an extractor head adopted by each branch of the dual-branch Siamese neural network. For example, the extractor head may be a ResNet18 network.

The ResNet18 network refers to a deep convolutional neural network including 18 layers of trainable parameters.

In some embodiments, improvements to the ResNet18 network include: replacing an original three-channel convolution kernel (7×7, stride=2) of the ResNet18 network with a single-channel convolution kernel to adapt to grayscale images; and removing a terminal fully connected layer and directly outputting a 512-dimensional feature vector after global average pooling.

In some embodiments, the dual-branch Siamese neural network may include two extractor heads, wherein one extractor head is provided in each branch, and output results of the two extractor heads are respectively denoted as G(X) and G(Y).

In some embodiments, the processor may replace the original three-channel convolution kernel (7×7, stride=2) of the ResNet18 network with a single-channel convolution kernel according to the following formula:

$${W}_{new} = \frac{1}{3} {\sum }_{c = 1}^{3} {W}_{original , c}$$

wherein W_{new} represents a weight of the new single-channel convolution kernel, c represents a channel, and W_{original, c} represents a weight of a c-th channel in the original three-channel convolution kernel. In some embodiments, the processor may use a weights of a pretrained ResNet18 network as W_{original, c}.

The terminal fully connected layer refers to a classification output layer at an end of the ResNet18 network.

In some embodiments, the 512-dimensional feature vector after global average pooling may be described by the following expression:

G(A)=GAP(ResNet18(a))

wherein G(A) represents the 512-dimensional feature vector output after the global average pooling on an original image a; ResNet18(a) represents performing forward propagation on the input image a through the ResNet18 network to output feature maps; and GAP (ResNet18(a)) represents performing the global average pooling (GAP) on the feature maps output by the ResNet18 model. The processor may average the feature maps of each channel to obtain a numerical value, thereby finally outputting the 512-dimensional feature vector.

A feature vector refers to a numerical vector obtained after the global average pooling.

In some embodiments, the feature vector may comprehensively reflect appearance patterns. The appearance patterns refer to patterns automatically learned by the feature extractor during a training process. In some embodiments, the appearance patterns are used to distinguish visual feature combinations corresponding to different appearance states of coffee beans. The appearance patterns may reflect appearance differences of coffee beans in surface texture, volume size and plumpness, overall shape and contour, or the like. Features related to the surface texture include surface roughness, local spot distribution, texture uniformity, or the like. Features related to the volume size and plumpness include an effective occupied area ratio of a coffee bean in an image, compactness of grayscale distribution, or the like. Features related to the overall shape and contour include an overall contour shape of a coffee bean and whether abnormal attachment or structural defects exist, for example, floating beans, moldy beans, shell-attached beans, and shriveled beans.

In some embodiments, the processor may input the training set into the improved feature extractors to obtain 512-dimensional feature vectors. The 512-dimensional feature vectors are the feature extraction results output from the two extractor heads, respectively. The 512-dimensional feature vectors output by the two improved feature extractors may be respectively denoted as G(X) and G(Y).

In some embodiments of the present disclosure, by performing targeted modifications to the ResNet18 network, the coffee bean defect detection model can be better adapted to a grayscale coffee bean image detection scenario. The single-channel convolution kernel design directly processes grayscale inputs, avoiding information redundancy caused by RGB conversion and reducing computational cost. By removing the terminal fully connected layer and retaining the 512-dimensional feature vector output after the global average pooling, rich spatial feature information is preserved while the count of parameters and a risk of overfitting are reduced. As a result, the coffee bean defect detection model can still achieve high accuracy and recall under small-sample conditions, thereby satisfying industrial real-time detection requirements.

The difference vector D refers to a vector obtained by performing element-wise subtraction between two feature vectors. For example, For two 512-dimensional feature vectors G(X) and G(Y), the difference vector D=G(X)-G (Y), where D is also a 512-dimensional vector.

The L2 norm difference refers to a Euclidean norm of the difference vector D, which is a Euclidean distance between the two feature vectors. The L2 norm difference is calculated by computing the square of each element of the difference vector D, summing these squares, and then taking the square root to obtain a scalar value.

In some embodiments, the processor may perform element-wise subtraction on the two feature vectors, G(X) and G(Y), obtained through feature extraction to generate the difference vector D, and subsequently calculate the L2 norm of the difference vector D to obtain the L2 norm difference. For example, the processor may generate the difference vector D and the L2 norm difference according to the following expression:

$$D = G ( X ) - G ( Y )$$

$$L 2 norm difference = {‖ D ‖}_{2} = \sqrt{{\sum }_{K = 1}^{512} {D}_{K}^{2}}$$

where D represents the difference vector, G(X) and G(Y) represent the feature extraction results, D_{K}=G_{K}(X)−G_{K}(Y) represents a K-th element of the difference vector D.

The three-layer classifier refers to a classifier formed by serially connecting two fully connected layers and an output layer.

For example, the three-layer classification structure may include a first fully connected layer, a second fully connected layer, and an output layer.

The first fully connected layer refers to a classifier configured to perform dimensionality reduction on the difference vector D.

The second fully connected layer refers to a classifier configured to further perform dimensionality reduction on the difference vector D after a first dimensionality reduction.

The output layer refers to a classifier configured to map the difference vector D after two rounds of dimensionality reduction into a one-dimensional parameter.

In some embodiments, the processor may construct the three-layer classifier, and the difference vector D sequentially passes through the first fully connected layer, the second fully connected layer, and the output layer to output the similarity score.

For example, the difference vector D sequentially passes through the first fully connected layer and the second fully connected layer, and batch normalization, ReLU activation, and a Dropout operation are sequentially performed. An expression for the difference vector D passing through the first fully connected layer is as follows:

h₁=Dropout(ReLU(BN(D*W₁+b₁)))

where W₁∈R^{512*256}, b₁∈R²⁵⁶, and a Dropout rate is 50% to prevent overfitting; BN denotes performing the batch normalization; W₁ and b₁ respectively represent a weight term and a bias term of the first fully connected layer; ReLU denotes an activation function; and h₁ represents an output result of the first fully connected layer.

The ReLU activation refers to truncating negative input values to zero while keeping positive input values unchanged.

The Dropout operation refers to randomly setting 50% of output values to zero, thereby forcing the three-layer classifier to learn more robust feature representations.

An expression for the difference vector D passing through the second fully connected layer is as follows:

h₂=Droupt(ReLU(BN(h₁*W₂+b₂))

where W₂∈R^{256*128}, b₂∈R¹²⁸, and a Dropout rate is 50% to prevent overfitting; BN denotes performing the batch normalization; W₂ and b₂ respectively represent a weight term and a bias term of the second fully connected layer; and h₂ represents an output result of the second fully connected layer.

An expression for the difference vector D passing through the output layer is as follows:

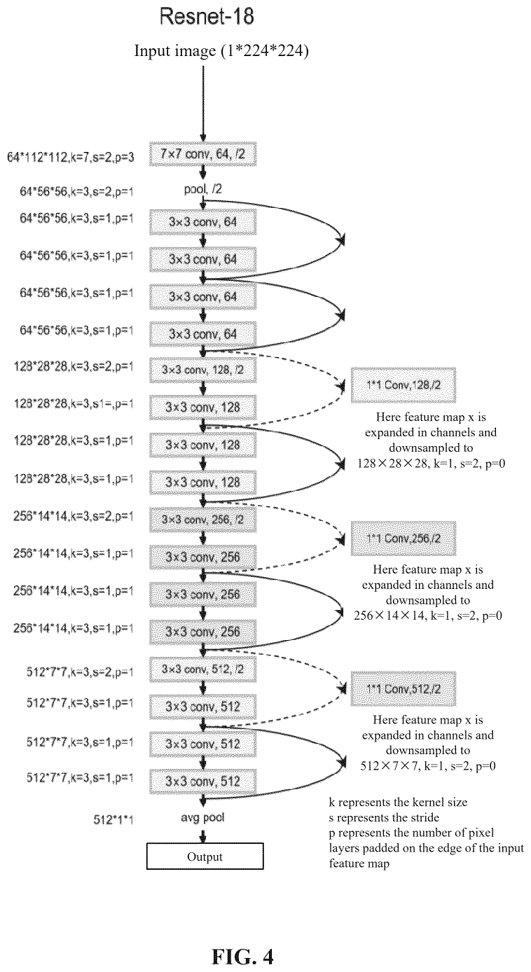

Score=σ(h₂*W₃+b₃)

$$σ = \frac{1}{1 + {e}^{- x}} ,$$

where σ denotes a Sigmoid function, and x represents an input value; W₃ and b₃ respectively represent a weight term and a bias term of the third fully connected layer; Score represents the similarity score; W₃∈R^{128*1}, b₃∈R¹²⁸. An exemplary structure of the improved ResNet18 network is shown in FIG. 4.

In some embodiments of the present disclosure, by means of the improved dual-branch Siamese neural network architecture, high accuracy and recall are achieved under small-sample conditions for the image data of each type of coffee bean, with a short single inference time, thereby providing strong robustness and economic feasibility for industrial deployment.

In 130, validating and adjusting the trained coffee bean defect detection model using the validation set by employing a mixed-precision training strategy and a dynamic learning rate adjustment technique.

The mixed-precision training strategy refers to a strategy for improving training efficiency while ensuring training stability. In some embodiments, the mixed-precision training strategy includes forward propagation, backward propagation, and parameter updating.

During the forward propagation, FP16 (half-precision floating-point) is used to calculate a loss function, expressed as:

$${L}_{FP 16} = - \frac{1}{N} {\sum }_{i = 1}^{N} [ {y}_{i} log ( {Score}_{i} ) + ( 1 - {y}_{i} ) log ( 1 - {Score}_{i} ) ]$$

where LFP16 represents a binary cross-entropy loss function computed using FP16, N represents a count of samples, yᵢ represents a ground-truth label of an i-th sample (0 or 1, indicating a “different-type coffee bean pair” or a “same-type coffee bean pair”), and Score; represents a predicted similarity score of the i-th sample (Sigmoid output in a range of [0, 1]).

During the backward propagation, gradients are dynamically scaled to FP32 precision using a GradScaler to ensure training stability, as expressed below:

∇_{FP32}=GradScaler(∇_{FP16})

where ∇_{FP16} represents a backward-propagated gradient of L_{FP16}, and ∇_{FP32} represents a gradient vector scaled to FP32 precision by the GradScaler.

The parameter updating is performed using an Adam optimizer according to the following rule:

$${θ}_{t + 1} = {θ}_{t} - η * \frac{{a}_{t}}{\sqrt{{b}_{t}} + ϵ}$$

where θₜ represents model parameters at a t-th iteration, η represents a learning rate, ϵ is a constant greater than zero for preventing a denominator from being zero, ϵ>0, and a and b respectively represent bias-corrected first-order and second-order moment estimates.

In some embodiments, the processor may dynamically adjust the learning rate based on a preset training period. The preset training period may be five training epochs and may be preset by technical personnel based on requirements.

In some embodiments, the dynamic learning rate adjustment technique includes using a StepLR strategy to dynamically adjust the learning rate. An initial learning rate is set to 0.0005, the learning rate decays by 50% every five training epochs, and L2 weight decay is introduced to suppress overfitting.

In some embodiments of the present disclosure, mixed-precision training is implemented by an autocast context manager of PyTorch to automatically perform FP16 conversion, and gradients are dynamically scaled using the GradScaler. A training period is set to ten epochs, 800 image pairs are iterated in each epoch, and an early stopping condition is evaluated on the validation set.

In some embodiments, the processor may validate and adjust parameters of the coffee bean defect detection model based on the validation set by using various techniques.

For example, the mixed-precision training strategy may be adopted, in which FP16 is used to compute a loss function during forward propagation, and gradients are dynamically scaled to FP32 precision by a GradScaler during backward propagation. An Adam optimizer is used for parameter updating, an initial learning rate is set to 0.0005, and the learning rate decays by 50% every five training epochs. When the loss function satisfies a preset condition, model training is completed to obtain a trained coffee bean defect detection model. The preset condition may include convergence of the loss function, a count of iterations reaching a threshold (e.g., ten training epochs), or triggering an early stopping mechanism due to no performance improvement on the validation set over consecutive epochs (i.e., the loss function no longer decreases). The early stopping mechanism refers to a mechanism for terminating training iterations in advance. In some embodiments, when the loss function continuously increases over a plurality of adjacent iterations, the early stopping mechanism is triggered.

In 140, performing defect detection inference on the validated and adjusted coffee bean defect detection model using the test set to complete the coffee bean defect detection. That is to say, the processor may perform performance testing on the validated and adjusted coffee bean defect detection model using the test set. During model application, the processor may use the coffee bean defect detection model that has passed the performance testing to perform defect detection on images of coffee beans to be tested (hereinafter referred to as defect detection inference), so as to complete the coffee bean defect detection.

In some embodiments, the processor may input the test set into the validated and adjusted coffee bean defect detection model (i.e., the coffee bean defect detection model obtained in step 130), determine a similarity score for each image pair, and determine coffee beans in the image pair based on a similarity threshold to output a classification result. The classification result is compared with a category of the coffee beans in an image corresponding to the classification result to determine whether the classification result is correct. In response to all classification results being correct, the coffee bean defect detection model passes the performance testing.

In some embodiments, the defect detection inference is performed as follows: an image of a coffee bean to be tested and a pre-stored normal coffee bean reference image are input into the dual-branch Siamese neural network obtained in step 130, and a similarity score is calculated. In response to the similarity score being lower than a similarity threshold, the coffee bean in the image to be tested is determined to be a defective coffee bean, and a classification result and a probability value are output. The similarity threshold refers to a parameter used to determine whether the coffee bean to be tested is a normal coffee bean. For example, the similarity threshold may be set to 0.5.

For example, if the similarity score Score≥0.5, the coffee bean is determined to be a normal coffee bean; if the similarity score Score<0.5, the coffee bean is determined to be a defective coffee bean, and a defect probability is output as:

Pdefect=1−Score

wherein Pdefect represents the defect probability.

For more details regarding defect detection inference, reference may be made to the relevant description below.

In some embodiments, prior to the defect detection inference, the processor may construct a plurality of image pairs based on a plurality of normal coffee bean reference images, input the plurality of image pairs into the dual-branch Siamese neural network to obtain similarity scores corresponding to the image pairs, and construct a similarity score set from the plurality of similarity scores. The similarity threshold used in the defect detection inference stage is determined based on the similarity score set. The acquisition of the similarity score set includes: after completion of training of the coffee bean defect detection model or during a validation stage of the coffee bean defect detection model, constructing a plurality of image pairs from normal coffee bean samples, inputting the image pairs into the dual-branch Siamese neural network, and obtaining similarity scores that reflect degrees of feature similarity among the normal coffee bean samples. The obtained plurality of similarity scores are used as statistical samples to form the similarity score set, which is used to characterize an overall similarity distribution state of the normal coffee bean samples in a feature space.

The similarity score set refers to a data set composed of a plurality of similarity scores obtained after image pairs formed from a plurality of normal coffee bean samples are input into the dual-branch Siamese neural network. In some embodiments, the similarity score set is used to characterize an appearance similarity degree between image pairs.

For example, after the model training is completed, a technician may construct a plurality of image pairs from normal coffee bean samples and input the image pairs into the dual-branch Siamese neural network to obtain a group of similarity scores, such as 0.82, 0.79, 0.85, and 0.76. The plurality of similarity scores jointly constitute the similarity score set.

The similarity distribution state refers to overall distribution characteristics of similarity scores in the similarity score set, and is used to characterize a central tendency and a degree of variation of similarity among normal coffee bean samples.

For example, when more than a preset proportion (e.g., 60%) of similarity scores in the similarity score set are concentrated within a preset high-similarity interval (e.g., 0.8 to 1.0), and a variation range (e.g., a standard deviation) of the similarity scores in the similarity score set is smaller than a preset threshold (e.g., 0.1), it indicates that the normal coffee bean samples exhibit high and stable similarity in the feature space. Conversely, when the similarity scores are distributed over a wide numerical interval (e.g., spanning 0.4 or more), and the variation range (e.g., the standard deviation) of the similarity scores in the set is greater than the preset threshold (e.g., 0.1), it indicates that appearance differences among the normal coffee bean samples are relatively significant, and the similarity distribution state exhibits high dispersion. The preset proportion, the preset high-similarity interval, the variation range of the similarity scores, the preset threshold, and the wide numerical interval may be set by a technician according to requirements.

It may be understood that, by describing the central tendency of the similarity score set using the similarity distribution state, the central tendency and the variation range of normal coffee bean samples can be quantitatively characterized, thereby enabling dynamic and adaptive adjustment of the similarity threshold. This significantly improves robustness of the system to appearance differences among coffee beans of different varieties and batches, effectively reduces risks of misclassification and missed detection, and, at the same time, allows a dispersion parameter to reflect production process stability in real time, providing data feedback for quality control and supporting multi-level quality grading. Accordingly, interpretability of abnormal determination is enhanced, and the detection system is upgraded from a static decision tool to an intelligent quality monitoring system having self-perception, dynamic adaptation, and continuous optimization capabilities.

The feature space refers to a multidimensional mathematical space composed of feature vectors obtained by performing feature extraction on the normal coffee bean reference images using the dual-branch Siamese neural network with shared weights.

In some embodiments, the similarity threshold used in the defect detection inference stage is dynamically determined based on the similarity score set of normal coffee bean samples, so as to reflect an actual distribution state of the normal coffee bean samples in the feature space.

For example, after completion of the model training or during the model validation stage, the processor first constructs a plurality of image pairs based on normal coffee bean samples, and inputs the image pairs into the dual-branch Siamese neural network with a shared-weight to obtain corresponding similarity scores, thereby forming a similarity score set. Based on the similarity score set, a statistical analysis is performed on the similarity distribution among the normal coffee bean samples, and the analysis results are organized in a distribution table, where the distribution table is used to reflect the distribution of the normal coffee bean samples across different similarity intervals (for example, a high-similarity interval, a medium-similarity interval, and a low-similarity interval). During a defect detection inference stage, the similarity threshold used in the defect detection inference stage is selected according to the distribution table corresponding to the similarity score set.

It may be understood that values within a transition interval from the medium-similarity interval to the low-similarity interval may be used as the similarity threshold adopted in the defect detection inference stage. In some embodiments, the similarity threshold may be selected by a technician according to practical requirements.

The high-similarity interval refers to a similarity interval in the similarity score set in which high-value scores account for a large proportion; for example, values greater than 0.8 account for a high proportion (for example, approximately 60%) in the similarity score set, indicating that most normal coffee bean samples have high similarity to each other within the high-similarity interval. The medium-similarity interval refers to a similarity interval in the similarity score set in which mid-range values account for a large proportion; for example, values ranging from 0.5 to 0.8 account for a high proportion (for example, approximately 30%) in the similarity score set, indicating that the similarity between some normal coffee bean samples is at a medium level within this interval. The low-similarity interval refers to a similarity interval in the similarity score set in which low-value scores account for a large proportion; for example, values less than 0.5 account for a high proportion (for example, approximately 10%) in the similarity score set, indicating that the similarity between a small number of normal coffee bean samples is low within the low-similarity interval.

In some embodiments, the similarity threshold adopted in the defect detection inference stage is determined based on statistical characteristics of the similarity score set, where the statistical characteristics at least include a mean parameter of the similarity scores and a dispersion parameter. The processor may determine the mean parameter based on the similarity score set to represent an overall similarity level among the normal coffee bean samples, and determine the dispersion parameter of the similarity score set to represent a fluctuation range of the similarity scores among the normal coffee bean samples. Based on the mean parameter and the dispersion parameter, the similarity threshold used in the defect detection inference stage is determined according to a preset threshold generation rule.

The Statistical characteristics refer to numerical features used to quantify the similarity distribution state among the normal coffee bean samples.

The mean parameter refers to a statistical parameter obtained by performing statistical processing on a plurality of similarity scores in the similarity score set. The mean parameter is used to represent an overall similarity level among the normal coffee bean samples.

The dispersion parameter refers to a statistical parameter used to represent a fluctuation condition of each similarity score in the similarity score set relative to the overall level. In some embodiments, the dispersion parameter may be used to reflect a degree of dispersion of the similarity distribution state among the normal coffee bean samples.

The preset threshold generation rule refers to a rule used to convert the statistical characteristics into the similarity threshold adopted in the defect detection inference stage. For example, the preset threshold generation rule includes, but is not limited to, rules for determining the similarity threshold based on a mean value, a weighted mean, a combination of a mean value and dispersion, statistical ranking, or the like.

In some embodiments, the preset threshold generation rule may be expressed as:

T=a−k*b

where T denotes the similarity threshold adopted in the defect detection inference stage; a denotes the mean parameter; b denotes the dispersion parameter; and k denotes a preset adjustment coefficient (k>0).

The preset adjustment coefficient refers to a coefficient used to control a downward adjustment magnitude of the similarity threshold relative to the mean parameter. The preset adjustment coefficient may be determined as values such as 1, 1.5, or 2 according to requirements.

The downward adjustment magnitude refers to a reduction amount of the similarity threshold adopted in the defect detection inference stage relative to the mean parameter, and is used to enable the similarity threshold to dynamically adapt to the similarity distribution state of the normal coffee bean samples.

In some embodiments, a technician may determine a corresponding preset adjustment coefficient based on a preset table using the dispersion parameter, and then determine the similarity threshold adopted in the defect detection inference stage. The preset table includes a correspondence between dispersion parameters and preset adjustment coefficients, and the preset table may be determined by the technician according to requirements.

In some embodiments of the present disclosure, by determining the threshold adopted in the defect detection inference stage based on the mean parameter and the dispersion parameter of the similarity score set, the similarity threshold not only reflects an overall similarity level of the normal coffee bean samples, but also takes into account a fluctuation range among the normal coffee bean samples, thereby avoiding an overly lenient or overly strict threshold setting. This approach enables the defect determination threshold to fall within a reasonable interval of the similarity distribution of normal coffee beans, ensures a high pass rate for normal coffee beans, helps reduce a risk of misclassifying defective coffee beans as normal coffee beans, thereby improving accuracy and stability of the classification result.

In some embodiments of the present disclosure, prior to the defect detection inference stage, the similarity score set is constructed based on similarity scores among normal coffee bean samples, and the similarity threshold adopted for defect determination is determined accordingly, such that the similarity threshold can reflect an actual similarity distribution of normal coffee beans in a feature space of the Siamese neural network. Compared with an approach using a fixed threshold, this approach enables the similarity threshold to be adaptively adjusted in accordance with changes in the appearance distribution of normal coffee beans, thereby reducing a risk of misclassifying defective coffee beans as normal coffee beans while maintaining a high pass rate for normal coffee beans, and improving stability and reliability of the classification result.

In some embodiments, the pre-stored normal coffee bean reference images include a plurality of normal coffee bean prototype images. After completion of the model training, the processor may input the normal coffee bean samples used in the model training into a single-branch feature extractor of the trained dual-branch Siamese neural network to obtain corresponding feature vectors. Based on similarities among the feature vectors, clustering processing is performed on the feature vectors, and for each cluster, a representative sample or a corresponding feature vector is determined as a normal coffee bean prototype, such that a plurality of normal coffee bean prototypes jointly represent the distribution state of normal coffee beans in the feature space.

A normal coffee bean prototype image refers to a coffee bean sample that is determined, during manual or automatic inspection, to have no appearance defects and to meet preset quality standards. In some embodiments, normal coffee bean prototype images are used to represent a distribution of appearance features of normal coffee beans.

The single-branch feature extractor refers to a network branch of the dual-branch Siamese neural network, configured to perform feature extraction on image data of a single input. In some embodiments, the single-branch feature extractor is configured to map input image data to a feature vector representation. In some embodiments, the feature extractor of either branch of the dual-branch Siamese neural network may serve as the single-branch feature extractor.

In some embodiments, an input of the single-branch feature extractor may include normal coffee bean prototype images, and an output of the single-branch feature extractor may include feature vectors used to represent appearance features of coffee beans.

Normal coffee bean samples refer to coffee bean samples that are determined, during preprocessing or construction of the image pair dataset, to not include preset defect types and whose appearance features meet quality requirements for normal coffee beans.

In some embodiments, images corresponding to normal coffee bean samples are used to represent the distribution state of normal coffee beans in an appearance feature space.

In some embodiments, the processor may improve a modeling manner of normal coffee bean reference images by expanding a single normal coffee bean reference image into a plurality of normal coffee bean prototypes. By constructing a plurality of normal coffee bean prototypes in the feature space, normal appearance patterns are modeled. The feature space refers to a mathematical space composed of 512-dimensional feature vectors extracted by the improved ResNet18 network.

In some embodiments, during the defect detection inference stage, the processor may respectively input the image of a coffee bean to be tested and each of a plurality of normal coffee bean prototype images into the dual-branch Siamese neural network, and obtain a plurality of similarity scores (i.e., each similarity score represents a similarity between the test image and one normal coffee bean prototype image). Subsequently, processor may the select a maximum value from the plurality of similarity scores as the similarity score used for the defect detection inference. The classification result of the defect detection inference is determined based on the similarity score corresponding to the normal coffee bean prototype that is closest to the test coffee bean in the feature space (i.e., the prototype with the highest similarity score).

In some embodiments of the present disclosure, by selecting a normal coffee bean prototype that is closest in appearance to the coffee bean to be tested as a basis for determination, defect detection can adapt to diversity in appearances of normal coffee beans, reduce misclassification, and improve detection stability.

Similarity refers to a measurement result used to evaluate a degree of proximity between appearance features of different normal coffee bean samples in the dual-branch Siamese neural network.

In some embodiments, the similarity score is determined based on a distance relationship or a degree of difference between feature vectors, and is used to reflect a degree of similarity among appearance patterns of different coffee bean samples.

In some embodiments, the processor may group normal coffee bean samples having similar appearance features into a same cluster in the feature space, and for each cluster, select one representative sample (which may be a sample closest to a cluster center) from corresponding normal coffee bean samples or feature vectors as a normal coffee bean prototype, to represent a position of such type of normal coffee beans in the feature space, thereby jointly replacing an original single normal reference image with a plurality of normal coffee bean prototypes.

A normal coffee bean prototype refers to a representative sample selected from corresponding normal coffee bean samples or feature vectors. In some embodiments, the normal coffee bean prototype may be a sample closest to the cluster center.

In some embodiments of the present disclosure, by constructing a plurality of normal coffee bean prototypes in a Siamese neural network feature space, appearance diversity of normal coffee beans can be explicitly modeled, thereby avoiding bias caused by a single normal reference and reducing a probability that normal coffee beans are misclassified as defective coffee beans.

The classification result refers to a classification of a coffee bean to be tested output by the coffee bean defect detection model. For example, the classification result may indicate that the coffee bean to be tested is a normal coffee bean or a defective coffee bean.

The probability value refers to a probability that the coffee bean to be tested is classified as a defective coffee bean. The probability value may also be referred to as a defect probability.

In some embodiments of the present disclosure, the similarity score is calculated by the Siamese neural network, and based on the mixed-precision training strategy and the dynamic learning rate adjustment technique, accuracy and efficiency of coffee bean defect detection are improved, making the approach applicable to industrial automated inspection systems.

In some embodiments, the processor may further apply the classification result of coffee bean defect detection based on the dual-branch Siamese neural network to coffee bean defect detection inference, including: obtaining an image of a coffee bean to be tested; inputting the image of the coffee bean to be tested into the coffee bean defect detection model to obtain a classification result corresponding to the image of the coffee bean to be tested. Based on the classification result, a corresponding processing operation is performed on the coffee bean to be tested, where the processing operation includes at least one or more of classifying the coffee bean to be tested, rejecting the coffee bean to be tested, or adjusting a conveying path. In response to the classification result indicating that the coffee bean to be tested is a normal coffee bean, the coffee bean to be tested is retained on a current conveying path or conveyed to a collection region corresponding to normal coffee beans. In response to the classification result indicating that the coffee bean to be tested is a defective coffee bean, the coffee bean to be tested is removed from the current conveying path or conveyed to a collection region corresponding to defective coffee beans.

In some embodiments, the method for coffee bean defect detection based on the Siamese neural network may be executed by a coffee bean intelligent sorting system. The coffee bean intelligent sorting system includes modules such as an image acquisition device, a computing processing unit, a control unit, and an actuator.

The image acquisition device refers to an industrial camera disposed above the conveying path and forming a preset imaging angle with respect to a conveying direction of a conveyor belt. In some embodiments, when coffee beans pass through a preset detection region, the image acquisition device triggers an image acquisition operation and transmits acquired image data to the computing processing unit.

The conveying path refers to a movement trajectory of the coffee beans during a detection process. The preset imaging angle refers to a preset included angle between the industrial camera and the conveying direction of the conveyor belt, for example, 45°. The preset imaging angle may be preset by technical personnel according to actual requirements.

The preset detection region refers to a specific section on the conveying path that is preset for triggering image acquisition.

The computing processing unit refers to a module configured to convert image data acquired by the image acquisition device into a classification result. The computing processing unit may include components such as a processor and a memory. In some embodiments, the computing processing unit runs the coffee bean defect detection model on the processor to perform defect detection inference on the received image data acquired by the image acquisition device and outputs the corresponding classification result.

The control unit is communicatively connected to the computing processing unit and is configured to receive the classification result and generate and output a corresponding control instruction. In some embodiments, after receiving the classification result, the control unit generates the corresponding control instruction according to preset control logic and transmits the control instruction to the actuator. In some embodiments, the computing processing unit and the control unit may be integrated into the processor.

The preset control logic refers to decision rules that are preset in the control unit and are used to generate the control instruction for the actuator based on the classification result.

The control instruction refers to a control signal that is generated by the control unit based on the preset control logic and the classification result and is transmitted to the actuator to drive the actuator to perform a physical action. For example, the control instruction at least includes whether to trigger a rejection action and whether to adjust the conveying path.

The actuator refers to a hardware device that directly executes the control instruction. For example, the actuator may include a conveyor belt, a diverter baffle, an air-blowing device, and a push rod. In some embodiments, the actuator performs physical actions according to the control instruction, and different actuators correspond to different coffee bean collection channels.

The conveyor belt refers to a device configured to carry coffee beans and move the coffee beans along the conveying path. The diverter baffle refers to a guiding component configured to switch the conveying path of the coffee beans. The air-blowing device refers to a device configured to blow light-weight defective coffee beans (such as floating beans and shriveled beans) to a designated region (such as the collection region corresponding to defective coffee beans) by airflow. The push rod refers to a component configured to push the defective coffee beans into a designated region (such as the collection region corresponding to defective coffee beans). The coffee bean collection channel refers to a dedicated path structure configured to guide coffee beans to corresponding collection regions in a classified manner.

The conveying path refers to a path for conveying coffee beans.

The collection region refers to a region for collecting coffee beans. For example, the collection region may be a storage box.

In some embodiments, a coffee bean to be tested enters a preset detection region along the conveyor belt. The image acquisition device acquires an image of the coffee bean to be tested and transmits the image to the computing processing unit. The computing processing unit performs defect detection inference on the image of the coffee bean to be tested based on the coffee bean defect detection model. The coffee bean defect detection model outputs a classification result. The control unit receives the classification result, generates a control instruction according to the preset control logic and the classification result, and transmits the control instruction to the actuator. In response to the classification result indicating that the coffee bean to be tested is a normal coffee bean, the coffee bean to be tested is kept on the current conveying path or is conveyed to the collection region corresponding to normal coffee beans. In response to the classification result indicating that the coffee bean to be tested is a defective coffee bean, the coffee bean to be tested is rejected from the current conveying path or is conveyed to the collection region corresponding to defective coffee beans.

In some embodiments of the present disclosure, by applying the coffee bean classification result obtained from the Siamese neural network to an actual coffee bean detection process, the classification result is no longer used merely for data analysis or model output, but are directly used to control practical processing operations such as coffee bean classification, rejection, or conveying path adjustment, thereby realizing automated detection and sorting of coffee beans.

To verify the present disclosure, performance experiments, ablation experiments, and model inference experiments were conducted on the model constructed according to the present disclosure.

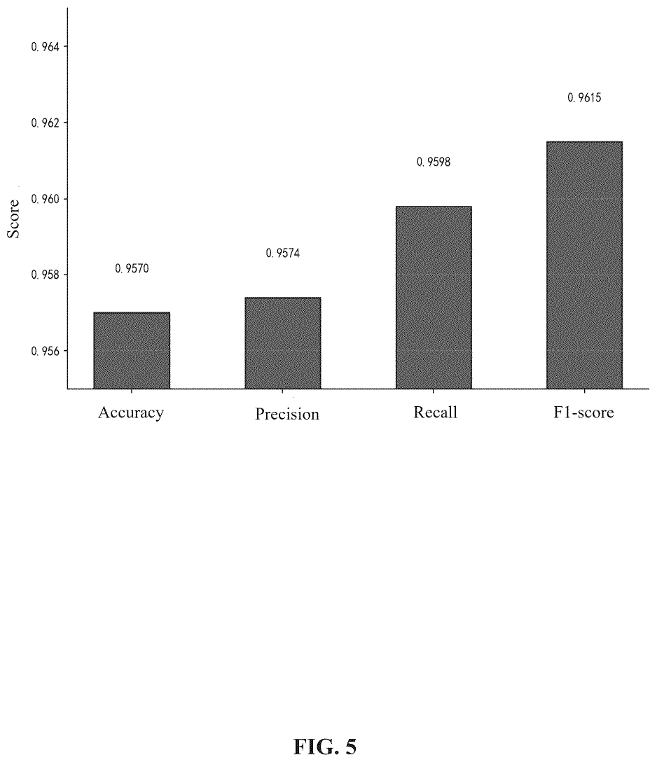

FIG. 5 is a diagram illustrating evaluation results of test classification performance according to some embodiments of the present disclosure.

The purpose of the performance experiments is to evaluate the performance of the Siamese neural network in a coffee bean defect detection task. The coffee bean defect detection model is trained and tested on a coffee bean defect dataset, and evaluation metrics including accuracy, precision, recall, and F1-score are adopted to assess the model performance. The results are shown in Table 1 and FIG. 5. Hereinafter, the coffee bean defect detection model is also referred to as the model.

Accuracy refers to a proportion of coffee beans that are correctly classified by the coffee bean defect detection model.

Precision refers to a proportion of coffee beans that are classified as defective coffee beans and are actually defective coffee beans.

Recall refers to a proportion of defective coffee beans that are correctly classified.

TABLE 1
Model Training and Validation Performance

| Category | Accuracy | Precision | Recall | F1-Score |
|---|---|---|---|---|
| Shriveled beans | 0.9547 | 0.9418 | 0.9686 | 0.9551 |
| Shell-attached | 0.9766 | 0.9762 | 0.9768 | 0.9765 |
| beans | | | | |
| Floating beans | 0.9919 | 0.9901 | 0.9936 | 0.9918 |
| Mody beans | 0.9920 | 0.9983 | 0.9856 | 0.9919 |

As shown in Table 1, the method of the present disclosure achieves favorable performance in the defect detection task, with high accuracy and recall, and is capable of effectively identifying coffee bean defects, thereby achieving high detection precision.

The purpose of the ablation experiments is to verify the effectiveness of the key components of the present disclosure. Specifically, experiments are conducted by removing key modules from a baseline model to analyze the impact of each component on detection performance. The key components include the feature extractor, the batch normalization (BN), the Dropout operation, and the L2 norm. The experimental results are shown in Tables 2, 3, 4, and 5.

TABLE 2
Performance comparison of different feature extractors

| Feature | Accuracy | Recall | Precision | |
|---|---|---|---|---|
| Extractor | (%) | (%) | (%) | F1-score |
| Present | 95.70% | 95.74% | 95.98% | 0.9615 |
| disclosure | | | | |
| (ResNet18) | | | | |
| ResNet34 | 93.73% | 93.66% | 92.31% | 0.9344 |
| ResNet50 | 90.85% | 91.88% | 91.10% | 0.9109 |
| MobileNetV2 | 89.48% | 82.51% | 85.28% | 0.8821 |
| ConvNet | 92.98% | 92.46% | 93.13% | 0.9293 |

The improved ResNet18 network adopted in the present disclosure alleviates the vanishing gradient problem through a residual connection structure. Experimental results demonstrate that, in the coffee bean defect classification task, the F1-score is improved by 2.71%, 5.06%, and 7.94% compared with ResNet34, ResNet50, and MobileNetV2, respectively.

TABLE 3
Performance comparison of regularization techniques

| | Accuracy | Recall | Precision | |
|---|---|---|---|---|
| Regularization technique | (%) | (%) | (%) | F1-Score |
| BN + Dropout | 95.70% | 95.74% | 95.98% | 0.9615 |
| Without BN | 90.12% | 83.74% | 95.73% | 0.8916 |
| Without Dropout | 91.43% | 88.56% | 95.11% | 0.9123 |
| Without BN + Dropout | 87.63% | 81.96% | 93.27% | 0.8789 |

In the present disclosure, the dropout rate is set to 50%. Under the collaborative effect of batch normalization and Dropout, the model achieves an F1-score of 0.9615. Removal of either component results in performance degradation.

TABLE 4
Performance comparison of feature matching strategies

| | Accuracy | Recall | Precision | |
|---|---|---|---|---|
| Feature Matching Strategy | (%) | (%) | (%) | F1-Score |
| L2 norm | 95.70% | 95.74% | 95.98% | 0.9615 |
| L1 norm | 86.91% | 93.03% | 83.81% | 0.8811 |
| Cosine similarity | 91.01% | 95.35% | 88.26% | 0.9229 |

Compared with the L1 norm and cosine similarity, the L2 norm-based difference computation strategy achieves superior recall, precision, and F1-score, and exhibits stronger capability in distinguishing subtle surface defect features of coffee beans.

TABLE 5
Performance comparison of loss functions

| | Accuracy | Recall | Precision | |
|---|---|---|---|---|
| Loss Function | (%) | (%) | (%) | F1-Score |
| Present disclosure (binary | 95.70% | 95.74% | 95.98% | 0.9615 |
| cross-entropy loss for a | | | | |
| binary classification | | | | |
| problem) | | | | |
| Contrastive loss | 93.85% | 90.48% | 95.29% | 0.9368 |
| Triplet loss | 89.23% | 91.35% | 88.31% | 0.8928 |

As can be seen from the above tables, removal of the key components leads to degraded detection performance, indicating that these components play an important role in improving the performance of the method of the present disclosure.

The purpose of the model inference experiments is to further analyze the recognition performance of the model on samples of different categories and to verify its generalization capability. Five groups of representative samples are selected for detailed inference testing, and the classification accuracy and stability of the model are evaluated. The results are shown in Table 6.

TABLE 6
Inference results for five representative samples

| | | Similarity | Classification |
|---|---|---|---|
| Sample ID | Predicted category | Probability | Result |
| N-2043 | Normal coffee beans | 0.9059 | Correct |
| D-float-82 | Floating beans | 0.2850 | Correct |
| D-shell-15 | Shell-attached beans | 0.1164 | Correct |
| D-moldy-161 | Moldy beans | 0.0038 | Correct |
| D-shrink-16 | Shriveled beans | 0.0099 | Correct |

As shown in Table 6, the model exhibits robust classification performance for normal coffee beans and is able to accurately distinguish normal beans from defective beans. For example, sample N-2043 is correctly identified as a normal coffee bean. Meanwhile, the model also demonstrates high reliability in defect classification tasks. For example, the moldy bean sample D-moldy-161 and the shriveled bean sample D-shrink-16 are both correctly classified without misclassification. The model inference experiments indicate that, even when the appearance features of certain defective beans are relatively subtle, the model can still effectively recognize them. This demonstrates that the model has strong stability and robustness in extracting and distinguishing defect features.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

It should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. A method for coffee bean defect detection based on a Siamese neural network, comprising:
S1: obtaining image data of normal coffee beans and four types of defective coffee beans, performing a preprocessing operation on the image data, and dividing the preprocessed image data into a training set, a validation set, and a test set according to a preset ratio;
S2: constructing a coffee bean defect detection model based on a dual-branch Siamese neural network, and training the coffee bean defect detection model using the training set to obtain a similarity score;
S3: validating and adjusting the trained coffee bean defect detection model using the validation set by employing a mixed-precision training strategy and a dynamic learning rate adjustment technique;
S4: performing defect detection inference on the validated and adjusted coffee bean defect detection model using the test set to complete the coffee bean defect detection;
wherein the defect detection inference includes:
inputting an image of a coffee bean to be tested and a pre-stored normal coffee bean reference image into the dual-branch Siamese neural network obtained in S3, and calculating a similarity score;
in response to the similarity score being lower than a similarity threshold, determining the coffee bean to be tested as a defective coffee bean, and outputting a classification result and a probability value.

2. The method of claim 1, wherein the obtaining image data of normal coffee beans and four types of defective coffee beans, performing a preprocessing operation on the acquired image data, and dividing the preprocessed image data into a training set, a validation set, and a test set according to a preset ratio includes:
S1.1: obtaining the image data of the normal coffee beans and the four types of defective coffee beans, wherein the four types of defective coffee beans include: floating beans, moldy beans, shell-attached beans, and shriveled beans;
wherein the obtaining the image data includes: using a high-resolution industrial camera to obtain the image data of the normal coffee beans and the four types of defective coffee beans under a fixed lighting condition and in an environment with a consistent image background;
S1.2: constructing an image pair dataset from the obtained images using a balanced sampling strategy, and dividing the image pair dataset according to the preset ratio;
wherein a manner for constructing the image pair dataset includes: annotating each image pair, each image pair including two images, with a binary classification label, wherein a label “1” indicates that the two images belong to a same type of coffee bean, and a label “0” indicates that the two images belong to different types of coffee beans;
S1.3: converting Red, Green, Blue (RGB) images in the image pair dataset into single-channel grayscale images, setting the converted single-channel grayscale images to have two different pixel configurations for the model training and the defect detection inference, respectively, and performing pixel-value normalization;
wherein the two different pixel configurations include a pixel configuration for the model training and a pixel configuration for the defect detection inference, and the pixel configuration for the defect detection inference and the pixel configuration for the model training are set to different values.

3. The method of claim 1, wherein the constructing a coffee bean defect detection model based on a dual-branch Siamese neural network, and training the coffee bean defect detection model using the training set to obtain a similarity score includes:
S2.1, constructing improved feature extractors of the dual-branch Siamese neural network, and inputting the training set into the improved feature extractors to obtain feature extraction results from the improved feature extractors;
S2.2, subtracting the feature extraction results to obtain a difference vector D, and calculating an L2 norm of the difference vector D to obtain an L2 norm difference; and
S2.3, constructing a three-layer classifier, wherein the difference vector D sequentially passes through a first fully connected layer, a second fully connected layer, and an output layer, so as to output the similarity score;
wherein, when the difference vector D sequentially passes through the first fully connected layer and the second fully connected layer, batch normalization, ReLU activation, and a Dropout operation are sequentially performed.

4. The method of claim 1, wherein in the step of validating and adjusting the trained coffee bean defect detection model using the validation set by employing a mixed-precision training strategy and a dynamic learning rate adjustment technique, the mixed-precision training strategy includes forward propagation, backward propagation, and parameter updating; wherein
the forward propagation uses FP16 to calculate a loss function;
the backward propagation dynamically scales gradients to FP32 precision by using a GradScaler;
an Adam optimizer is used for the parameter updating; and
the dynamic learning rate adjustment technique includes dynamically adjusting a learning rate by using a StepLR strategy.

5. The method of claim 3, wherein in the step of constructing improved feature extractors of the dual-branch Siamese neural network, and inputting the training set into the improved feature extractors to obtain feature extraction results from the improved feature extractors, an improvement manner includes:
using an improved ResNet18 network as an improved feature extractor for an extraction head of each branch,
wherein improvements to a ResNet18 network include:
S2.1.1, replacing an original three-channel convolution kernel of the ResNet18 network with a single-channel convolution kernel, so as to adapt to grayscale images; and
S2.1.2, removing a terminal fully connected layer and directly outputting a 512-dimensional feature vector after global average pooling.
